(19) United States
(12) Patent Application Publication
(10) Pub. No.: US 2012/0108703 A1
(43) Pub. Date: May 3, 2012

(54) SURFACE PROTECTIVE AGENT

(75) Inventor: Shinichi Tamura, Koriyama (JP)

(73) Assignee: NITTO BOSEKI CO., LTD., Fukushima-shi (JP)

(21) Appl. No.: 13/277,533

(22) Filed: Oct. 20, 2011

(30) Foreign Application Priority Data
Oct. 29, 2010 (JP) 2010-243008

(51) Int. Cl. C08L 85/04; C08K 5/521; C08L 63/00; C08K 5/524

(52) U.S. Cl. 523/435; 524/139; 524/140

(57) ABSTRACT

The present invention provides a surface protective agent having good hard coating properties and good adhesion properties to metal.

The surface protective agent comprises:
a polymer comprising a reaction product obtained by reacting (a) a silane compound containing an amino group represented by the following formula:

R₄₋ₙ—Si—(OR′)ₙ

(wherein R represents an organic group containing an amino group; R′ represents methyl, ethyl or propyl; and n is an integer selected from 1 to 3) with (b) at least one boron compound selected from the group consisting of H₃BO₃ and B₂O₃, in an amount of the component (b) being 0.02 mol or larger per mol of the component (a);
(c) a metal alkoxide and/or a condensation product of a metal alkoxide; and
(d) a phosphorus compound.

### TECHNICAL FIELD

The present invention relates to a surface protective agent having good hard coating properties and good adhesion properties to metal.

### BACKGROUND ART

Many conventional inorganic coating compositions having a transparency and hard coating properties are known. Of them, silicic materials comprising an organosilane compound and a boron compound were either polymerized ones which have undergone a hydrolytic reaction of said both compounds in an aqueous phase or unpolymerized ones without both compounds being allowed to react with each other. This hydrolytic reaction is usually carried out by a sol-gel method, but it has disadvantages in that it requires a complicate process and necessitates a long time for the production.

### SUMMARY OF THE INVENTION

### Problem to be Solved by the Invention

When a polymer composition containing an organosilane-based compound was used as a surface protective agent for metal, there were problems that an adhesion ability to a substrate was decreased to be likely to occur a peeling in case a film thickness was thick and a hardening was insufficient. Thus, a long curing period of time was necessary for obtaining sufficient adhesion properties, and a hardening acceleration by heating was necessary to be conducted for obtaining sufficient adhesion properties in a short period of time.

For instance, Patent Document 1 describes a coating agent using, as a raw material, a polymer composition containing a metal alkoxide, an organosilane compound and a boron compound.

However, even by using such a polymer composition, a coating having good hard coating properties was obtained but there was room for improvement in adhesion properties to metal.
Patent Document 1: WO 2008/044521

As a result of concentrated studies on the subject matter, the present inventors found that a further addition of a phosphorus compound such as triethyl phosphate to a coating agent containing a metal alkoxide, an organosilane compound and a boron compound could provide a coating having good hard coating properties and good adhesion properties to metal even after drying under normal temperature and normal humidity.

The present invention provides a surface protective agent having good film forming properties and capable of providing satisfactory hardness (toughness) to the produced film and further good adhesion properties to metal.

### Means for Solving the Problem

The present invention solves the above problems and provides a surface protective agent comprising:

a polymer comprising a reaction product obtained by reacting (a) a silane compound containing an amino group represented by the following formula:

R₄₋ₙ—Si—(OR′)ₙ

(wherein R represents an organic group containing an amino group; R′ represents methyl, ethyl or propyl; and n is an integer selected from 1 to 3) with (b) at least one boron compound selected from the group consisting of H₃BO₃ and B₂O₃, in an amount of the component (b) being 0.02 mol or larger per mol of the component (a);

(c) a metal alkoxide and/or a condensation product of a metal alkoxide; and

(d) a phosphorus compound.

### Advantages of the Invention

The present invention can provide a surface protective agent having good hard coating properties and good adhesion properties to metal under normal temperature and normal humidity. The surface protective agent of the present invention can be applied as a coating agent for a metal, glass, ceramics, and plastics.

### EMBODIMENT FOR CARRYING OUT THE INVENTION

When the component (a) (a silane compound containing an amino group) and the component (b) (a boron compound) are mixed with each other, they are reacted to form a limpid and viscous liquid and the liquid is solidified in several minutes to several ten minutes. This can be accounted for as follows: the boron compound functions as a crosslinking agent through the medium of the amino group in the component (a) to cause a polymerization of these components, resulting in forming a viscous liquid and its solidification. The component (a) is liquid. In the present invention, no water is used in reacting the component (a) and the component (b).

The component (a) is a silane compound containing an amino group represented by the following formula:

R₄₋ₙ—Si—(OR′)ₙ

(wherein R represents an organic group containing an amino group; R′ represents methyl, ethyl or propyl; and n is an integer selected from 1 to 3.)

Here, R represents an organic group containing an amino group, the examples thereof including, though not limited to, monoaminomethyl, diaminomethyl, triaminomethyl, monoaminoethyl, diaminoethyl, triaminoethyl, tetraminoethyl, monoaminopropyl, diaminopropyl, triaminopropyl, tetraminopropyl, monoaminobutyl, diaminobutyl, triaminobutyl, tetraminobutyl, phenylaminopropyl, aminomethylbenzylaminopropyl and organic groups having an alkyl or aryl group with a greater number of carbon atoms than those mentioned above. Of these organic groups, γ-aminopropyl, aminoethyl and aminopropyl are especially preferred, with γ-aminopropyl being the most preferred.

R′ in the formula of the component (a) represents methyl, ethyl or propyl, with methyl and ethyl being preferred.

Letter n in the formula of the component (a) is an integer selected from 1 to 3. n is preferably 2 or 3, especially preferably 3.

Thus, γ-aminopropyltriethoxysilane and N-β-(aminoethyl)-γ-aminopropyltrimethoxysilane are particularly preferred as the component (a).

The component (b) is at least one boron compound selected from the group consisting of H₃BO₃ and B₂O₃. The component (b) is preferably H₃BO₃ and B₂O₃.

The amounts of both components used in the reaction are adjusted so that the amount of the component (b) will be 0.02 mol or larger, preferably 0.02 to 8 mol, more preferably 0.02 to 5 mol, per mol of the component (a).

If the amount of the component (b) is less than 0.02 mol per mol of the component (a), the time required for solidification may prolong or the mixture may not be solidified sufficiently. On the other hand, if the amount of the component (b) exceeds 8 mol, the component (b) may remain undissolved in the component (a).

The mixing conditions (temperature, mixing time, mixing method, etc.) of the components (a) and (b) of the surface protective agent of the present invention can be properly selected. Under ordinary conditions of room temperature, the mixture becomes a limpid and viscous liquid and is solidified in several minutes to several ten minutes. The time required for the solidification and the viscosity and rigidity of the obtained reaction product differ also depending on the ratio of the boron compound used in the reaction.

The boron compound (b) is preferably offered as an alcohol solution of a boron compound prepared by dissolving the boron compound in an alcohol with a carbon number of 1 to 7. Examples of the alcohols with a carbon number of 1 to 7 include methyl alcohol, ethyl alcohol, various kinds of propyl alcohol, various kinds of butyl alcohol and glycerin, of which methyl alcohol, ethyl alcohol and isopropyl alcohol are preferred. Use of such an alcohol solution can shorten the time required for dissolving the component (b) in the component (a). The higher the concentration of the boron compound in the alcohol, the more preferable for handling of the solution.

The said reaction product is preferably a reaction product obtained by reacting the component (a) with the component (b) without going through a step of hydrolysis using water.

Examples of the metal in the metal alkoxide of the component (c) include, though not limited to, Si, Ta, Nb, Ti, Zr, Al, Ge, B, Na, Ga, Ce, V, Ta, P and Sb. Si, Ti, Zr and Al are preferred, with Si, Ti and Zr being more preferred. Si and Ti are especially preferred as the component (c) is preferably liquid. Exemplary of the alkoxide (alkoxyl group) in the metal alkoxide of the component (c) can include methoxy, ethoxy, propoxy, butoxy and other alkoxyl groups having a greater number of carbon atoms than those mentioned above. Of these alkoxyl groups, methoxy, ethoxy, propoxy and butoxy are preferred, with methoxy and ethoxy being especially preferred.

The metal alkoxide of the component (c) specifically can include tetramethoxysilane, tetraethoxysilane, tetrapropoxysilane, tetrabutoxysilane, methyltrimethoxysilane, methyltriethoxysilane, methyltripropoxysilane, methyltributoxysilane, tetramethoxytitanium, tetraethoxytitanium, tetrapropoxytitanium, tetrabutoxytitanium, tetramethoxyzirconium, tetraethoxyzirconium, tetrapropoxyzirconium and tetrabutoxyzirconium. Preferred one can include tetraethoxysilane, tetramethoxysilane, methyltriethoxysilane and methyltrimethoxysilane. More preferred one can include tetraethoxysilane and tetramethoxysilane.

The amount of the metal alkoxide of the component (c) used is preferably 10 mol or less, more preferably 0.1 to 5 mol, per mol of the component (a). If the component (c) is less than 0.1 mol per mol of the component (a), it may become difficult to obtain the effect of the addition of the component (c) as mentioned above. If the component (c) exceeds 5 mol, the product may become cloudy.

The condensation product of a metal alkoxide of the component (c) can include a condensation product of a metal alkoxide represented by at least one formula selected from the group consisting of the following formulae (cl) and (c2):

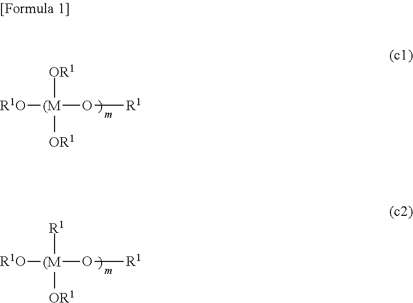

(wherein R¹ represents independently an alkyl group, part of which may be hydrogen, and R¹ may be identical to or different from each other; m is an integer selected from 2 to 20; and M represents at least one metal selected from the group consisting of Si, Ti and Zr).

The component (c) can be added in the course of or after the reaction between the components (a) and (b). Addition of the component (c) is helpful for enhancing hardness of the product while improving its electrical and chemical properties. Also, since the composition is made into a viscous liquid by the addition of component (c), it can be worked into fibers or films.

The amount of the condensation product of a metal alkoxide of the component (c) added is preferably 2 to 50 mol, more preferably 4 mol or more, calculated in terms of weight of the metal alkoxide monomer, per mol of the component (a). When the amount of the component (c) is too large, hardness of the product tends to lower. On the other hand, when the amount of the component (c) is too small, there may take place a reduction of hardness and/or the problem of chemical durability of the product due to the low Si content. Additionally, when the amount of the component (c) is too large, there is a tendency that a curing time for obtaining the surface protective agent of the present invention becomes long.

R¹ in the formula of the component (c) represents independently an alkyl group, part of which may be hydrogen, and R¹ may be identical to or different from each other. Specifically, R¹ is a methyl group, an ethyl group, a propyl group, a butyl group or other alkyl groups with a carbon number equal to or greater than these groups, of which methyl group and ethyl group are preferred.

m in the formula of the component (c) is an integer selected from 2 to 20, preferably 3 to 10, most preferably 5.

M in the formula of the component (c) represents at least one metal selected from the group consisting of Si, Ti and Zr, of which Si and Ti are preferred, with Si being the most preferred.

The metal alkoxide monomeric units constituting the component (c) can include tetramethoxysilane, tetraethoxysilane, tetrapropoxysilane, tetrabutoxysilane, methyltrimethoxysilane, methyltriethoxysilane, methyltripropoxysilane, methyltributoxysilane, tetramethoxytitanium, tetraethoxytitanium, tetrapropoxytitanium, tetrabutoxytitanium, tetramethoxyzirconium, tetraethoxyzirconium, tetrapropoxyzirconium and tetrabutoxyzirconium. Preferred one can include tetraethoxysilane, tetramethoxysilane, methyltriethoxysilane and methyltrimethoxysilane.

In the case when the component (c) is represented by the above-shown formula (c1), it is preferably a condensation product (pentamer) of tetraethoxysilane or a condensation product (pentamer) of tetramethoxysilane. In the case when the component (c) is represented by the above-shown formula (c2), it is preferably a condensation product (pentamer) of methyltriethoxysilane or a condensation product (pentamer) of methyltrimethoxysilane.

The surface protective agent of the present invention can further contain a synthetic resin (e). The synthetic resins usable as the component (e) are not specifically defined in the present invention, and there can be used, for instance, thermosetting resins, thermoplastic resins and ultraviolet-curing resins. More specifically, it is possible to use the synthetic resins ranging widely in polymerization degree (molecular weight), which include, for instance, acrylic resins, epoxy resins, polyester resins, amino resins, urethane resins, furan resins, and silicone resins. Of these synthetic resins, epoxy resins, dipentaerythritol hexaacrylate, epoxy acrylate, vinyl ester resins, bisphenol A, bisphenol F, oligovinyl ester, oligoester acrylate and the like are preferred.

The component (d) is a phosphorus compound. Adhesion properties to metal of the surface protective agent of the present invention are enhanced by adding the component (d).

The component (d) is preferably a phosphorus compound which is soluble in the component (a) or alcohols. The component (d) is at least one phosphorus compound selected from the group consisting of triethyl phosphate, trimethyl phosphate, triethyl phosphite, and trimethyl phosphite.

The amount of the phosphorus compound of the component (d) added is not particularly limited. However, in case the surface protective agent having a transparency and hard coating properties particularly require a water resistance in the present invention, the amount of the component (d) added can be preferably from 0.5 to 10 parts by weight, more preferably from 1 to 3 parts by weight, per 100 parts by weight of other components excluding solvents and the component (d) of the surface protective agent of the present invention.

Meanwhile, in case the phosphorus compound of the component (d) added is triethyl phosphate, the amount of the component (d) added is preferably from 0.3 to 30% by weight, more preferably from 0.3 to 20% by weight, further preferably from 0.5 to 10% by weight, in the surface protective agent of the present invention.

The surface protective agent can be used by diluting it with an organic solvent, preferably an alcohol with a carbon number of 1 to 7 which can include methyl alcohol, ethyl alcohol, various kinds of propyl alcohol, various kinds of butyl alcohol and glycerin, of which methyl alcohol, ethyl alcohol and isopropyl alcohol are more preferred.

The surface protective agent of the present invention can be used as a coating agent for a metallic part etc. and is useful as a surface protective agent for e.g. an electrical appliance and an auto part.

The amount of the component (e) used is preferably 60% by weight or less, more preferably 1 to 55% by weight, based on the overall amount of the composition. If the component (e) is less than 1% by weight, it may become difficult to obtain the effect of addition of the component (e) as mentioned above. If the component (e) exceeds 60% by weight, it may become necessary to add a resin curing agent, and there may not be obtained a high hardness.

Additionally, a resin curing agent or a surface active agent can be also added for controlling a curing time and hardness.

The present invention will be further explained in detail by showing the embodiments thereof as follows.

The test samples were prepared by mixing the components in the weight ratios as shown below. The surface protective agents were prepared by adding the boron compound (component (b)) and the metal alkoxide (component (c)) to the silane compound (component (a)), sufficiently reacting them with each other, and sequentially adding other components (component (d), component (e) and a diluent solvent etc.) thereto to modify it.

### Example 1

To 20 parts by weight (0.09 mol) of γ-aminopropyltriethoxysilane (component (a)) was added 0.5 part by weight (0.008 mol) of boric acid powder (component (b)) and 100 parts by weight (0.13 mol) of a pentamer of tetraethoxysilane (Ethyl Silicate 40 produced by COLCOAT CO., LTD.) (component (c)), and the mixture was stirred for 30 minutes. Then, 50 parts by weight of bisphenol A diglycidyl ether (EPICOAT 828 produced by Japan Epoxy Resin CO., LTD.) (component (e)) and 200 parts by weights of butyl acetate (diluent solvent) were added thereto, and the mixture was further stirred for 30 minutes to obtain a polymer composition. 1.8 parts by weight of triethyl phosphate (component (d)) was added thereto, and the mixture was further stirred for 30 minutes to obtain a test sample.

### Example 2

A test sample was prepared in the same way as in Example 1 except that 3.7 parts by weight of triethyl phosphate was added as the component (d).

### Example 3

A test sample was prepared in the same way as in Example 1 except that 11.0 parts by weight of triethyl phosphate was added as the component (d).

### Example 4

A test sample was prepared in the same way as in Example 1 except that 18.3 parts by weight of triethyl phosphate was added as the component (d).

### Example 5

A test sample was prepared in the same way as in Example 1 except that 1.8 parts by weight of trimethyl phosphate was added as the component (d).

### Example 6

A test sample was prepared in the same way as in Example 1 except that 1.8 parts by weight of trimethyl phosphite was added as the component (d).

### Example 7

A test sample was prepared in the same way as in Example 1 except that 1.8 parts by weight of triethyl phosphite was added as the component (d).

### Comparative Example 1

A test sample was prepared in the same way as in Example 1 except that component (d) was not used.

### Comparative Example 2

A test sample was prepared in the same way as in Example 1 except that 0.5 part by weight of triethyl phosphate was added as the component (d).

Each of the test samples prepared at Examples 1 to 7 and Comparative Examples 1 and 2 was coated on stainless steel (SUS 304#700 according to JIS (Japanese Industrial Standards): mirror finished stainless steel), and cured for 72 hours at a temperature of 23° C. and a humidity of 70±10% RH to form a coating. The following items of the resulting coatings were evaluated. Evaluation results are shown at Table 1.

### Film Thickness

Film thickness (coating thickness) was measured in accordance with the eddy-current testing methods by using a dual-type coating thickness tester (LZ-300J produced by Kett Electric Laboratory) and a probe for non-magnetic metals (NFe probe).

### Adhesion Properties

Adhesion properties were evaluated by the method of HS K5600-5-6. That is, based on JIS K5600-5-6 (Testing methods for paints/Adhesion test), the film was cut at 1 mm intervals in lattice pattern to prepare 100 pieces, a cellophane tape was attached thereon and was rapidly peeled therefrom, and adhesion properties were represented by “the number of normal pieces/100 pieces”.

### Pencil Hardness

Pencil hardness was evaluated by the method of JIS K5600-5-4 (at a load of 750±10 g).

### Appearance

Presence or absence of a crack and whitening were confirmed in accordance with a visual observation.

TABLE 1

| | Film thickness | Adhesion | Pencil | |
|---|---|---|---|---|
| | (μm) | properties | hardness | Appearance |
| Example 1 | 5 | 100/100 | 5H | no abnormality |
| Example 2 | 5 | 100/100 | 5H | no abnormality |
| Example 3 | 5 | 100/100 | 5H | no abnormality |
| Example 4 | 5 | 100/100 | 5H | no abnormality |
| Example 5 | 5 | 100/100 | 5H | no abnormality |
| Example 6 | 5 | 100/100 | 5H | no abnormality |
| Example 7 | 5 | 100/100 | 5H | no abnormality |
| Comparative | 5 | 0/100 | 5H | no abnormality |
| Example 1 | | | | |
| Comparative | 5 | 0/100 | 5H | no abnormality |
| Example 2 | | | | |

Each of the test samples prepared at Example 1 and Comparative Example 1 was coated on stainless steel (SUS304 (HL) according to JIS: hairline polished stainless steel) and copper to cure it at a temperature of 23° C. and a humidity of 70±10% RH for 72 hours to form a coating. Adhesion properties of the resulting coatings were evaluated according to the above method. Evaluation results are shown at Table 2.

TABLE 2

| Substrate | Example 1 | Comparative Example 1 |
|---|---|---|
| SUS304 (HL) | 100/100 | 0/100 |
| Copper | 100/100 | 0/100 |

### INDUSTRIAL APPLICABILITY

The surface protective agent of the present invention can be used as a coating agent for a metal, glass, ceramics, and plastics.

1. A surface protective agent comprising:
a polymer comprising a reaction product obtained by reacting (a) a silane compound containing an amino group represented by the following formula:
R₄₋ₙ—Si—(OR′)ₙ
(wherein R represents an organic group containing an amino group; R′ represents methyl, ethyl or propyl; and n is an integer selected from 1 to 3) with (b) at least one boron compound selected from the group consisting of H₃BO₃ and B₂O₃, in an amount of the component (b) being 0.02 mol or larger per mol of the component (a);
(c) a metal alkoxide and/or a condensation product of a metal alkoxide; and
(d) a phosphorus compound.

2. The surface protective agent according to claim 1, wherein the phosphorus compound (d) is a phosphorus compound which is soluble in the silane compound (a) containing an amino group or alcohols.

3. The surface protective agent according to claim 1, wherein the phosphorus compound (d) is at least one phosphorus compound selected from the group consisting of triethyl phosphate, trimethyl phosphate, triethyl phosphite, and trimethyl phosphite.

4. The surface protective agent according to claim 1, wherein the boron compound (b) is an alcohol solution of a boron compound prepared by dissolving the boron compound in an alcohol with a carbon number of 1 to 7.

5. The surface protective agent according to claim 1, wherein the silane compound of component (a) is at least one silane compound selected from the group consisting of γ-aminopropyltriethoxysilane and N-β-(aminoethyl)-γ-aminopropyltrimethoxysilane.

6. The surface protective agent according to claim 1, wherein the reaction product contains a reaction product obtained by reacting the component (a) with the component (b) in a molar ratio of (a):(b) of 1:0.02 to 5.

7. The surface protective agent according to claim 1, wherein the reaction product is a reaction product obtained by reacting the component (a) with the component (b) without going through a step of hydrolysis in which water is added.

8. The surface protective agent according to claim 1, wherein the metal in the component (c) is at least one element selected from the group consisting of Si, Ti and Zr.

9. The surface protective agent according to claim 1, wherein, as the metal alkoxide of the component (c), tetramethoxysilane and/or tetraethoxysilane is present in an amount of 10 mol or less per mol of the component (a).

10. The surface protective agent according to claim 1, wherein the component (c) comprises a condensation product of a metal alkoxide represented by at least one formula selected from the group consisting of the following formulae (c1) and (c2): 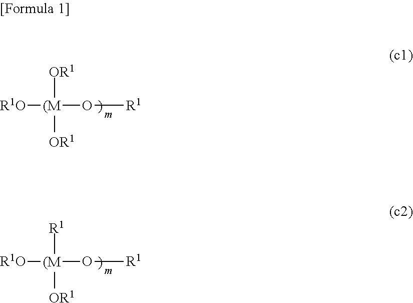
(wherein R¹ represents independently an alkyl group, part of which may be hydrogen, and R¹ may be identical to or different from each other; m is an integer selected from 2 to 20; and M represents at least one metal selected from the group consisting of Si, Ti and Zr).

11. The surface protective agent according to claim 10, wherein the condensation product of a metal alkoxide (c) is contained in an amount of 2 to 50 mol, calculated in terms of weight of the metal alkoxide monomer, per mol of the component (a).

12. The surface protective agent according to claim 10, wherein the metal alkoxide condensation product (c) is represented by the above-shown formula (c1), and is a condensation product of tetraethoxysilane or a condensation product of tetramethoxysilane.

13. The surface protective agent according to claim 1, further containing a synthetic resin (e).

14. The surface protective agent according to claim 13, wherein the synthetic resin (e) is an epoxy resin.
